(19) United States
(12) Patent Application Publication
(10) Pub. No.: US 2014/0375396 A1
(43) Pub. Date: Dec. 25, 2014

(54) WAVEGUIDE TUBE WITH ADJUSTABILITY BETWEEN OUTPUTS

(71) Applicant: HON HAI PRECISION INDUSTRY CO., LTD., New Taipei (TW)

(72) Inventor: CHIH-HAO LIN, New Taipei (TW)

(21) Appl. No.: 14/307,008

(22) Filed: Jun. 17, 2014

(30) Foreign Application Priority Data
Jun. 20, 2013 (TW) 102122039

(51) Int. Cl. H01P 5/12

(52) U.S. Cl. CPC H01P 3/12
USPC 333/125; 333/137

(57) ABSTRACT

A T-shaped waveguide tube with adjustability as between two outputs includes a T-shaped body, a T-shaped cover detachably mounted on the body, and a baffle. A number of pair of pillars can be mounted on a bottom board of the body. An energy entrance, a first energy output, and a second energy output are formed by the body, the cover, and the baffle. By installing the pillars in different configurations, wave energy from the energy entrance can be distributed equally or otherwise through the two outputs of the waveguide tube.

### FIELD

The subject matter herein generally relates to waveguides.

### BACKGROUND

Energy input into a T-shaped waveguide tube can be equally distributed to two outputs of the T-shaped waveguide tube.

### BRIEF DESCRIPTION OF THE DRAWINGS

Implementations of the present technology will now be described, by way of example only, with reference to the attached figures, wherein:

FIG. 1 is an exploded, isometric view of an exemplary embodiment of a T-shaped waveguide tube with adjustability.

FIG. 2 is an assembled, isometric view of the T-shaped waveguide tube of FIG. 1.

FIGS. 3-5 are diagrammatic views of different configurations of the T-shaped waveguide tube of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “inside” indicates that at least a portion of a region is partially contained within a boundary formed by the object. The term “comprising” means “including, but not necessarily limited to”; it specifically indicates open-ended inclusion or membership in a so-described combination, group, series and the like.

The present disclosure is in relation to a T-shaped waveguide tube 10 with adjustability.

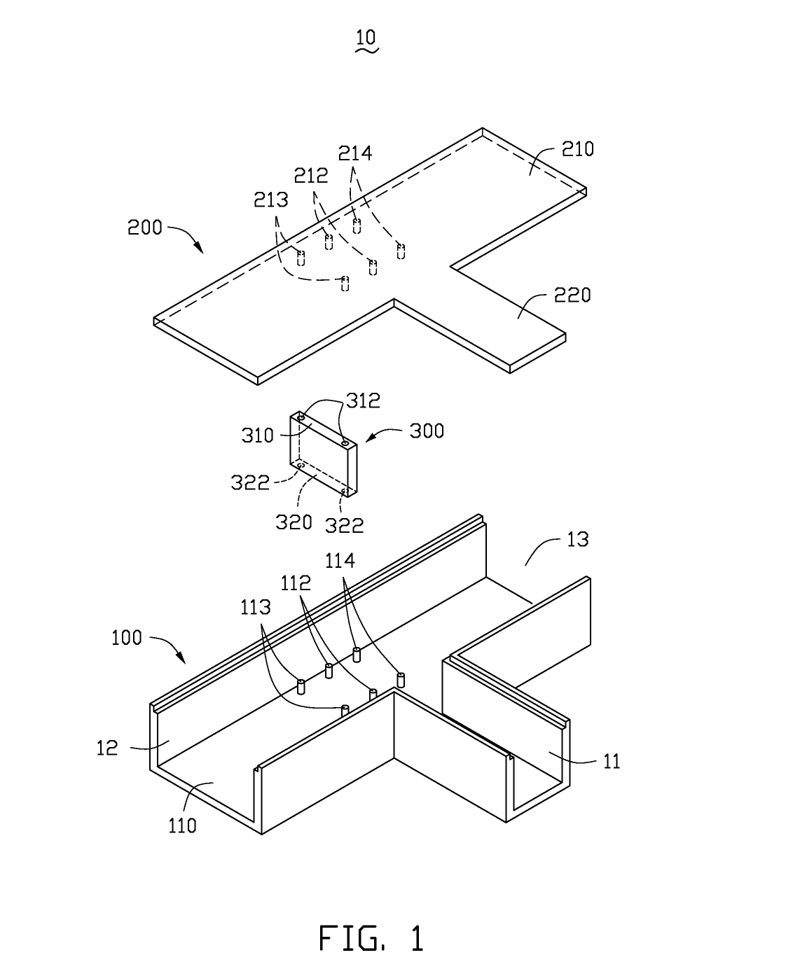

FIG. 1 illustrates an exemplary embodiment of the T-shaped waveguide tube 10 adjustability. The tube 10 can comprise a T-shaped body 100, a T-shaped cover 200 detachably mounted on the body 100, and an inside baffle 300.

In at least one embodiment, the cover 200 can comprise a first board 210 and a second board 220 vertically extending from center of the first board 210. A first, a second, and a third pairs of pillars 212, 213, 214 are formed on the center of the first board 210. The first pair of pillars 212 is formed on the center of the first board 210 and a straight line between the pillars of the first pair of pillars 212 is parallel to the extension direction of the second board 220. The second and the third pairs of pillars 213 and 214 are formed on either side of the first pair of pillars 212. A line between the pillars of the second pair of pillars 213 is parallel to a line between the pillars of the third pair of pillars 214 and both lines are parallel to the line between the pillars of the first pair of pillars 212.

A fourth, a fifth, and a sixth pairs of pillars 112, 113, 114 corresponding to the first, the second, and the third pairs of pillars 212, 213, 214, are formed on a bottom board 110 of the body 100. A pair of fixing holes 312 is defined in a top 310 of the baffle 300, and a pair of fixing holes 322 is defined in a bottom 320 of the baffle 300.

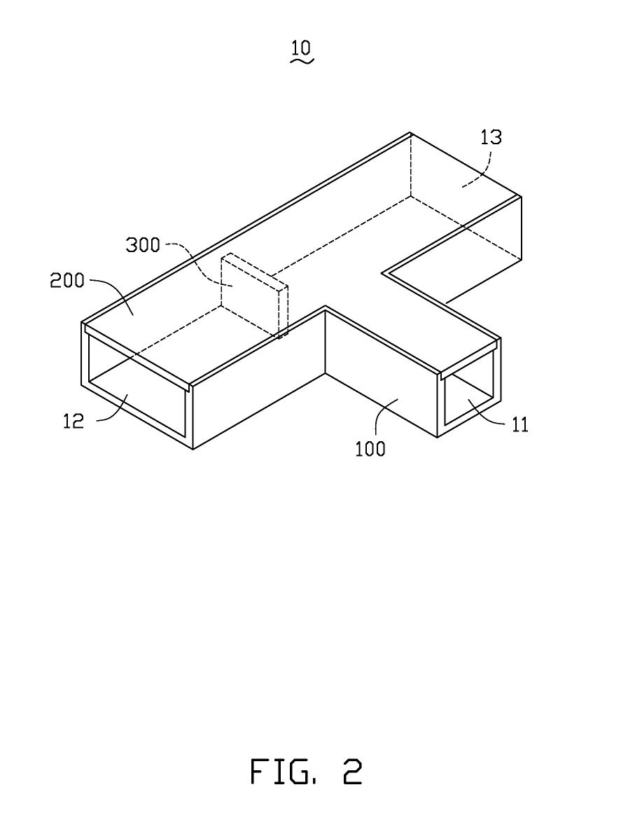

FIG. 2 illustrates the T-shaped waveguide tube 10 with adjustability as assembled. One pair of the first through third pairs of pillars 112, 113, 114, can be inserted in the fixing holes 322, thereby the baffle 300 is mounted on the bottom board 110 of the body 100. The cover 200 is mounted on the body 100 and one pair of the pillars 212, 213, 214, to correspond to the pair of pillars inserted in the fixing holes 322, is inserted in the fixing holes 312. The adjustability of the T-shaped waveguide tube 10 for energy transmission is formed by the body 100, the cover 200, and the baffle 300. The T-shaped waveguide tube 10 can comprise a first portion and a second portion extending from a center of the first portion in a perpendicular direction to the first portion. The entrance 11 at a distal end of the second portion receives wave energy, and the wave energy passes through a first energy output 12 and a second energy output 13 at two distal ends of the first portion.

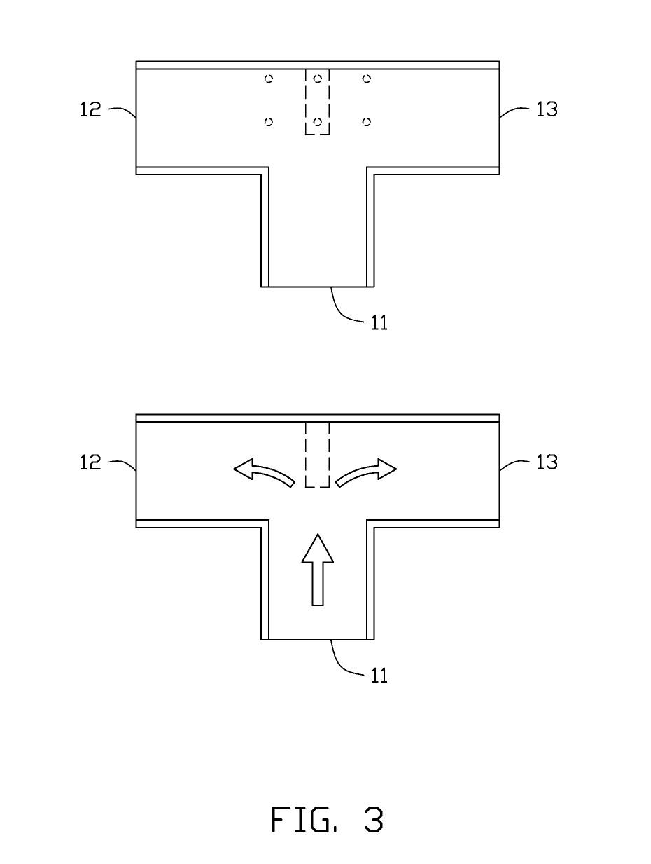

Referring to FIG. 3, for equal outputs, the baffle 300 is mounted on the bottom board 110 of the body 100 on the fourth pair of pillars 112, and the first pair of pillars 212 of the cover 200 is inserted in the fixing holes 312 of the baffle 300.

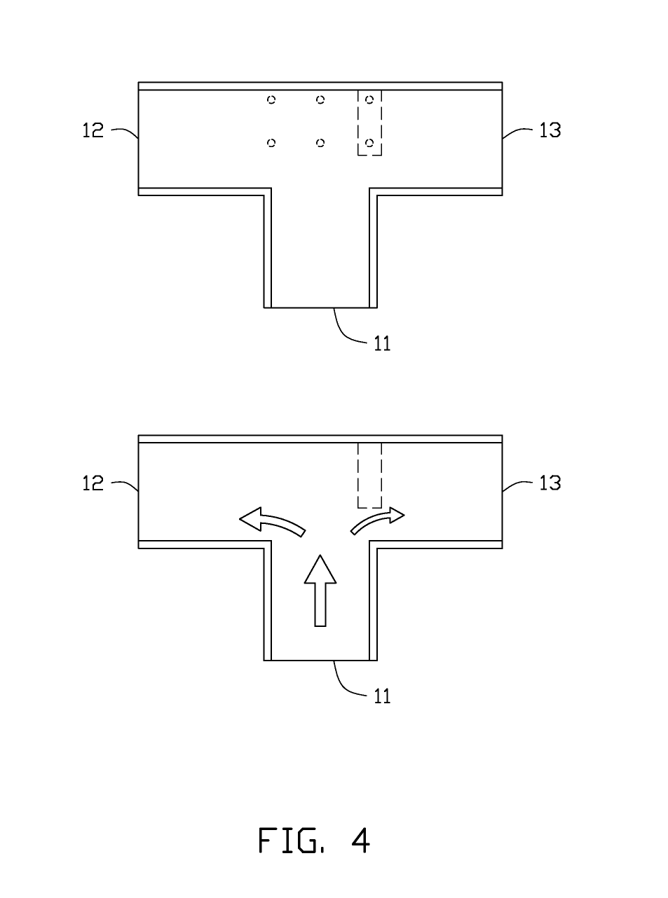

Referring to FIG. 4, when the wave energy is to be unequally distributed, the baffle 300 can be mounted on the bottom board 110 of the body 100 on the sixth pair of pillars 114, and the third pair of pillars 214 of the cover 200 inserted in the fixing holes 312 of the baffle 300. In this case, most of the wave energy is output through the first output 12.

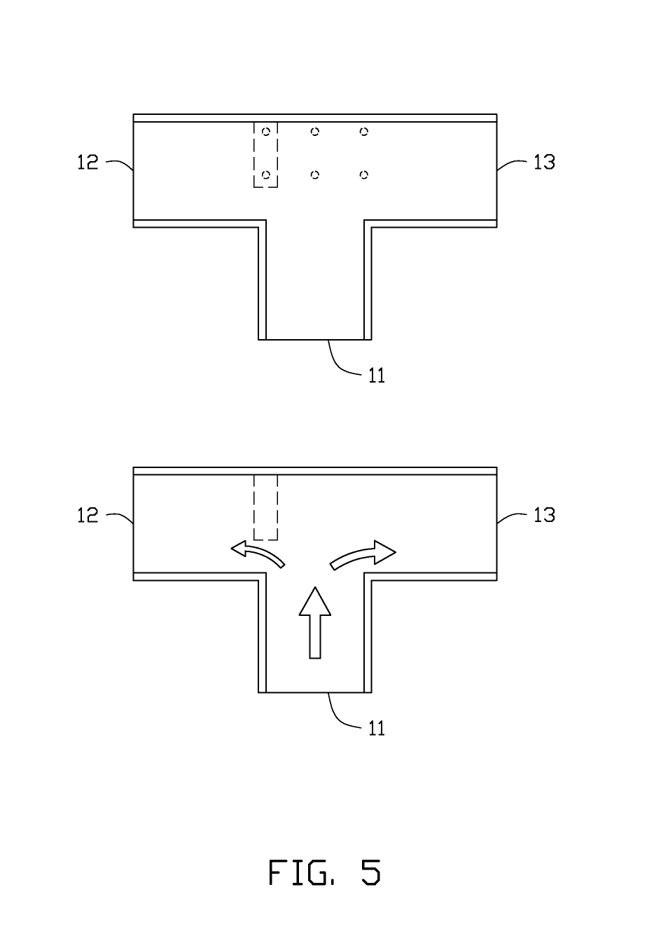

Referring to FIG. 5, the baffle 300 can be mounted on the bottom board 110 of the body 100 on the fifth pair of pillars 113, and the second pair of pillars 213 of the cover 200 be inserted in the fixing holes 312 of the baffle 300. In this case, most of the wave energy is output through the second output 13.

The T-shaped waveguide tube 10 can distribute energy with adjustability as between two outputs 12 and 13, by mounting the baffle 300 at different positions. In other embodiments, the number of the pillars can be greater.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A waveguide tube comprising:
a T-shaped body, wherein a plurality of pairs of pillars is formed on a bottom board of the body;
a T-shaped cover detachably mounted on the body; and
a baffle, wherein a pair of the fixing holes is defined in a bottom of the baffle for matching with each pair of the pillars of the body;
wherein an energy entrance, a first energy output, and a second energy output are formed by the body, the cover, and the baffle, the wave guide entrance is configured to receive wave energy, and the first energy output and the second energy output, are configurable to distribute wave energy received by the wave guide entrance through selective mounting of the baffle on different pair of pillars.

2. The waveguide tube of claim 1, wherein a plurality of pairs of pillars is formed on the cover, in corresponding with the pairs of pillars of the body, and a pair of the fixing holes is defined in a top of the baffle for matching with one pair of the pillars of the cover.

3. The waveguide tube of claim 1, wherein the number of the plurality of pairs of pillars of the body is three.

4. A waveguide tube comprising:
a T-shaped body;
a T-shaped cover detachably mounted on the body, wherein a plurality of pairs of pillars is formed on the cover;
a baffle, wherein a pair of the fixing holes is defined in a bottom of the baffle matching with each pair of the pillars of the cover;
wherein an energy entrance, a first energy output, and a second energy output are formed by the body, the cover, and the baffle, the wave guide entrance is configured to receive wave energy, and the first energy output and the second energy output, are configurable to distribute wave energy received by the wave guide entrance through selective mounting of the baffle on different pair of pillars.

5. The waveguide tube of claim 4, wherein the plurality of the pairs of pillars of the cover is three.
